(19) United States
(12) Patent Application Publication
(10) Pub. No.: US 2005/0143508 A1
(43) Pub. Date: Jun. 30, 2005

(54) Resin compositions with fluoropolymer filler combinations

(75) Inventors: Sandeep Tyagi, Bangalore (IN); Deval Gupta, Bangalore (IN); Raja Krishnamurthy, Bangalore (IN); Rajashekhar Shiddappa Totad, Bangalore (IN); Satish Kumar Gaggar, Parkersburg, WV (US)

Correspondence Address: Henry H. Gibson;GE Plastics, One Plastics Avenue, Pittsfield, MA, 01201, US

(73) Assignee: General Electric Company

(21) Appl. No.: 10/748,393

(22) Filed: Dec. 30, 2003

(51) Int. Cl. C08L 1/00

(52) U.S. Cl. 524/423; 524/502; 524/425; 524/431; 524/449; 524/451; 524/445; 524/493

(57) ABSTRACT

A thermoplastic resin composition is disclosed which comprises a matrix polymer, and a combination of a fluoropolymer that can be at least partially encapsulated by an encapsulating polymer, and a filler. Methods for making the thermoplastic resin composition and articles made of such compositions are also disclosed. The composition and article can have improved tensile modulus, ductility and impact properties.

### BACKGROUND OF THE INVENTION

This invention relates to resin compositions, methods to synthesize the resin composition and articles made from the compositions.

Many of the articles are manufactured by injection or other molding processes. In order to obtain good mechanical properties like high modulus different approaches have been tried in the past, most of them using filler to reinforce the polymer resin composition. Different types of fillers as glass fibers, aramid fibers, carbon fibers, mineral fillers, particulates fillers and nano fillers have been used to get high modulus. Addition of these fillers most often leads to brittle failure of the polymer resin and result in low impact strength. Improved ductility has been obtained in case of fillers like the aramid fillers, however the modulus obtained is very low. In addition these polymer resin compositions also have many processing issues apart from severe compatibility issues with most of the polymer matrices resulting in molding and flow related problems.

Although some of the above are very successful for the manufacture of molded articles, there is a continuing need for improved combinations of properties such as higher modulus along with ductility good impact, improved melt flow characteristics so that molding operations can be performed more rapidly and with improved economics. Also it is desirable that the article has good impact resistance and ductility without the consequent loss of other desirable characteristics. Typically, it is difficult to obtain good flow, high modulus, good ductility and impact strength in a particular resin composition.

Fluoroadditive like Polytetrafluoroethylene (PTFE) have excellent heat resistance, chemical resistance and electrical insulating properties and are widely used as a coating material due to the properties like water and oil repellent, being non-adhesive and self-lubricating. The high crystallinity and low intramolecular force give it a nature suitable to forming fibers with only minimal stress, and when combined with thermoplastic resins it is possible to achieve better molding workability and mechanical properties, allowing it to be used as an additive for thermoplastic resins. The use of relatively small amounts such as, for example, from 0.1 to about 1 percent by weight, of fluoroadditives as an anti-drip additive in flame retardant grades of thermoplastic resin molding compositions is known, for example, U.S. Pat. Nos. 4,810,739, 4,579,906, and 4,810,739. The use of sintered PTFE in highly filled thermoplastic compositions as low friction additives is disclosed in U.S. Pat. No. 5,879,791. A drawback exists, however, in that fluoroadditives like polytetrafluoroethylene has poor dispersibility in common thermoplastic resins, which contain no halogen atoms, and fails to uniformly disperse and it is also difficult to convert all of the polytetrafluoroethylene to fibers. In addition polytetrafluoroethylene fibers aggregate in the matrix resin making it impossible to obtain a uniform composition.

U.S. Pat. No. 5,804,654 teaches a process for production of encapsulated fluoropolymer. The encapsulant was any polymer or copolymer obtained by emulsion polymerization and it also teaches use of this tetrafluoroethylene polymerizate in a number of polymer compositions particularly for making fire retarded compositions. U.S. Pat. No. 5,962,587 and U.S. Pat. No. 6,025,441 are directed towards a thermoplastic resin composition comprising the polytetrafluoroethylene encapsulated or surrounded by the organic polymer particle where improved mechanical properties were observed. However, the prior art does not recognize or suggest combinations of materials like encapsulated polytetrafluoroethylene and the filler component obtaining an optimum balance of mechanical properties as described for this invention. Therefore, there is a continuing need for article possessing a balanced mechanical property profile including high modulus, good ductility and good impact strength.

### BRIEF DESCRIPTION OF THE INVENTION

In one aspect, the present invention provides a resin compositions a matrix polymer; and a combination of (1) a fluoro additive polymer wherein said fluoro additive polymer comprises a fluoropolymer at least partially encapsulated by an encapsulating polymer; and (2) a filler.

In another aspect, the present invention relates to a method of the making the resin composition of the present invention. Also disclosed are articles derived from said resin composition. In yet another aspect of the present invention the present inventors have unexpectedly discovered that the resin composition has improved properties.

Various other features, aspects, and advantages of the present invention will become more apparent with reference to the following description, examples, and appended claims.

### DETAILED DESCRIPTION OF THE INVENTION

The present invention may be understood more readily by reference to the following detailed description of preferred embodiments of the invention and the examples included herein. In this specification and in the claims, which follow, reference will be made to a number of terms which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein the term “polycarbonate” refers to polycarbonates incorporating structural units derived from one or more dihydroxy aromatic compounds and includes copolycarbonates and polyester carbonates.

The resin composition of the present invention comprises at least one matrix polymer, at least one a fluoropolymer and at least one filler. The fluoropolymer further comprises a fluoropolymer at least partially encapsulated by a encapsulating polymer. In one embodiment the resin composition possess improved mechanical properties such as high modulus, good ductility, good impact strength etc. In one embodiment of the present invention the matrix polymer and encapsulating polymer may comprise thermoplastics with glass transition temperatures of about 100° C. or greater.

Examples of materials suitable for use as the matrix polymer include, but are not limited to, amorphous, crystalline, and semi-crystalline thermoplastic materials such as: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate (PMMA), methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, and tetrafluoroethylenes (e.g., Teflons) and mixtures, copolymers, reaction products, blends and composites comprising at least one of the foregoing polymers.

In one embodiment, the matrix polymer can be homopolymers or copolymers of one of polyolefins, polycarbonates, polyesters, polyphenylene ethers and styrenic polymers, or a mixture thereof. In another embodiment the matrix polymer comprises a polyolefin selected from the group consisting of polyethylene, polypropylene, polybutylene, homopolymers, copolymers and mixtures thereof. In yet another embodiment of the present invention the matrix polymer comprises polycarbonate and mixtures, copolymers, reaction products, blends and composites comprising polycarbonate. Polycarbonates useful in the invention are preferably represented by the general formula I 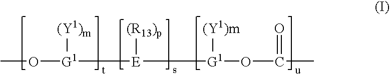
wherein G¹ represents an aromatic group, such as phenylene, biphenylene, naphthylene, and the like aromatic groups. E may be an alkylene or alkylidene group such as methylene, ethylene, ethylidene, propylene, propylidene, isopropylidene, butylene, butylidene, isobutylidene, amylene, amylidene, isoamylidene, and the like. Alternatively, E may consist of two or more alkylene or alkylidene groups connected by a moiety different from alkylene or alkylidene, such as an aromatic linkage, a tertiary amino linkage, an ether linkage, an ester linkage, (polycyclohexamethylenedicarboxylate, PCCD) a carbonyl linkage, a silicon-containing linkage (for example dimethylsiloxane), a sulfur-containing linkage such as sulfide, sulfoxide, sulfone, a phosphorus-containing linkage such as phosphinyl, phosphonyl, and like linkages. In addition, E may comprise a cycloaliphatic group. R¹³ represents hydrogen or a monovalent hydrocarbon group such as alkyl, aryl, aralkyl, alkaryl, cycloalkyl, and the like. Y¹ comprises a halogen (e.g., fluorine, bromine, chlorine, iodine, and the like); a nitro group; an alkenyl group, allyl group, the same as R⁸ previously described, an oxy group such as OR, and the like. In a preferred embodiment, Y¹ is inert to and unaffected by the reactants and reaction conditions used to prepare the polymer. The letter “m” represents any integer from and including zero through the number of positions on G¹ available for substitution; “p” represents an integer from and including zero through the number of positions on E available for substitution; “t” represents an integer equal to at least one; “s” is either zero or one; and “u” represents any integer including zero. These polycarbonates can be produced by any technique as described in the U.S. Pat. Nos. 5,484,875; 6,506,871, 6,518,319 and U.S. patent application Ser. No. 20030149223, or any other technique well known in the art. The molecular weight of the polycarbonate product may be manipulated by controlling, among other factors, the feed rate of the reactants, the type of extruder, the extruder screw design and configuration, the residence time in the extruder, the reaction temperature and the pressure reducing techniques present on the extruder. The molecular weight of the polycarbonate product may also depend upon the structures of the reactants, such as, activated aromatic carbonate, aliphatic diol, dihydroxy aromatic compound, and the catalyst employed.

The fluoropolymer consists of a fluoropolymer that is at least partially encapsulated by a encapsulating polymer. The fluoropolymers include but are not restricted to homopolymers and copolymers that comprise structural units derived from one or more fluorinated .alpha.-olefin monomers, wherein the term “fluorinated alpha.-olefin monomer” as used in this context means an .alpha.-olefin monomer that includes at least one fluorine atom substituent. In one embodiment the fluoropolymer is selected from a group consisting of fluorinated .alpha.-olefin copolymers comprising structural units derived from two or more fluorinated alpha.-olefin copolymers (like but not limited to poly(tetrafluoroethylene-hexafluoroethylene)), copolymers comprising structural units derived from one or more fluorinated monomers and one or more non-fluorinated monoethylenically unsaturated monomers that are copolymerizable with the fluorinated monomers such as, poly(tetrafluoroethylene-ethylene-propylene) copolymers. In one embodiment of the present invention the fluoropolymer comprises structural units of fluorinated alpha. monoethylenically unsaturated monomers including but not restricted to .alpha.-olefin monomers for example ethylene, propylene butene, acrylate monomers (such as methyl methacrylate, butyl acrylate), vinyl ethers, example cyclohexyl vinyl ether, ethyl vinyl ether, n-butyl vinyl ether, vinyl esters. In another embodiment of the present invention the fluoropolymer is at least one selected from polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene. In yet another embodiment of the present invention the fluoropolymer is polytetrafluoroethylene.

In one embodiment of the present invention the encapsulating polymer is selected from the group comprising vinyl polymers, acrylic polymers, polyacrylonitrile, polystyrenes, polyolefins, polyesters, polyurethanes, polyamides, polysulfones, polyimides, polyetherimides, polyphenylene ethers, polyphenylene sulfides, polyether ketones, polyether ether ketones, ABS resins, polyethersulfones, poly(alkenylaromatic) polymers, polybutadiene, , polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene, mixtures, copolymers, reaction products, and composites comprising at least one of the foregoing polymers. In one embodiment the encapsulating polymer is a polymer that is obtained by polymerization of monomers or mixtures of monomers employing emulsion-polymerization and particularly by radical polymerization route.

The encapsulating polymer in one embodiment may be polystyrenes, poly(.alpha.-alkylstyrenes) such as poly-.alpha.-methylstyrene, poly-.alpha.-ethylstyrene, poly-.alpha.-propylstyrene, poly-.alpha.-butylstyrene, poly-p-methylstyrene, halogenated polystyrene, acrylic polymers such as polyacrylonitrile, polymethacrylonitrile, poly(alkyl acrylates) such as poly(methyl acrylate), poly(ethyl acrylate), poly(propyl acrylate), poly(butyl acrylate), poly(alkyl methacrylates) such as poly(methyl methacrylate), poly(ethyl methacrylate), poly(propyl methacrylate), poly(butyl methacrylate), polybutadienes, vinyl polymers such as poly(vinyl acetate), poly(vinyl chloride), poly(vinylidene chloride), poly(vinylidene fluoride), poly(vinyl alcohols), and mixtures thereof. In another embodiment the encapsulating polymer may be copolymers of styrene, alkyl acrylate, alkyl methacrylate, vinyl chloride with another monomers such as an acrylonitrile, methacrylonitrile, alkyl methacrylate or alkyl acrylate monomer, grafted polymerizates such as, for example, polybutadiene, polychloroprene or styrene-butadiene, for example an acrylonitrile-butadiene copolymer rubber, an alkyl acrylate rubber, a styrene-butadiene rubber, an EPDM rubber or a silicon rubber. In a preferred embodiment the encapsulating polymer comprises styrene-acrylonitrile (SAN) and acrylonitrile-butadiene-styrene (ABS) copolymers, alpha.-alkyl-styrene-acrylonitrile copolymers, alpha.-methylstyrene-acrylonitrile (AMSAN) copolymers, styrene-butadiene rubbers (SBR), and combinations thereof. In yet another embodiment of the present invention the encapsulating polymer is copolymer of styrene-acrylonitrile and alpha.-methylstyrene-acrylonitrile.

In one embodiment, the fluoropolymer may also be present without the encapsulating polymer. It may be present in particulate form, aggregates of a plurality of particles dispersed in the matrix polymer. In another embodiment, the fluoropolymer could be in any form which may include but is not restricted to solid, powder form, particles, emulsions, dispersion, and the like.

The resin composition of the present invention further comprises fillers. The fillers generally comprise all common fillers and solid compounding ingredients or agents used in polymeric compounds. They include but are not restricted to materials of natural or synthetic and mineral or non-mineral origin, and of any configuration, such as spheres, plates or fibers, flakes, whiskers, which are available as fine particulate solids. These fillers also have sufficient thermal resistance to maintain their solid physical structure at least at the processing temperature of the particular polymeric material to be compounded therewith. Typical fillers include clays, carbon black, wood flour either with or without oil, various forms of silica including common sand, glass, metals, and oxides of metals such as aluminum oxide and titanium oxide, aluminum trihydrate and titanium dioxide magnesium oxide, calcium carbonate, barium carbonate, magnesium carbonate, barium sulfate, antimony trioxide, calcium silicate, diatomaceous earth, fuller earth, kieselguhr, mica, talc, slate flour, volcanic ash, cotton flock, asbestos, kaolin, sulfates of barium, calcium sulfate, titanium, nano clay, zeolites, vanadium oxide, wollastonite, titanium boride, zinc borate, tungsten carbide, ferrites, molybdium disulfide, asbestos, cristobalite, silica, aluminosilicates including Vermiculite, bentonite (bentonite, clay, montmorillonite, Na-montmorillonite, Ca-montmorillonite, hydrated sodium calcium aluminum magnesium silicate hydroxide, pyrophyllite, magnesium aluminum silicate, lithium aluminium silicates, zirconium silicates, Silica which includes precipitated or hydrated, fumed or pyrogenic, viterous or fused or colloidal, hydroxides of aluminium or ammonium or magnesium, zirconia, nanoscale titania, and combinations thereof. The inorganic oxide or mixture of 2 or more inorganic oxides may be used as fillers of the present invention such fillers include oxides of the metals in Periods 2, 3, 4, 5 and 6 of Groups Ib, IIb, IIa, IIIb, IVa, IVb (except carbon), Va, VIa, VIIIa and VIII of the Periodic Table. The fillers could be fibrous fillers which include fibers like glass fibers, basalt fibers, aramid fibers, carbon fibers, carbon nanofibers, carbon nanotubes, carbon buckyballs, ultra high molecular weight polyethylene fibers, melamine fibers, polyamide fibers, cellulose fiber, metal fibers, potassium titanate whiskers, aluminum borate whiskers.

In one embodiment the fillers to be used according to the invention is at least one selected from the group consisting of calcium carbonate, talc, glass fibers, carbon fibers, magnesium carbonate, mica, silicon carbide, kaolin, wollastonite, calcium sulfate, barium sulfate, titanium, silica, carbon black, ammonium hydroxide, magnesium hydroxide and aluminum hydroxide and combination thereof. In yet another embodiment of the present invention the filler is at least one of mica, talc, silicon carbide and combination thereof.

In one embodiment, the matrix polymer is in a range between about 30 percent by weight and about 95 percent by weight based on the total weight of the composition. In a second embodiment, the resin is in a range between about 50 percent by weight and about 90 percent by weight based on the total weight of the composition.

In one embodiment, the fluoropolymer at least partially encapsulated by an encapsulating polymer comprises the fluoropolymer in a range of between about 10 weight percent to about 90 weight percent by weight of the fluoropolymer, and the encapsulating polymer in the range of between about 90 weight percent to about 10 weight percent by weight of the encapsulating polymer. In a preferred embodiment of the present invention, the fluoropolymer at least partially encapsulated by an encapsulating polymer comprises the fluoropolymer in a range of between about 20 weight percent to about 80 weight percent by weight of the fluoropolymer, and the encapsulating polymer in the range of between about 80 weight percent to about 20 weight percent by weight of the encapsulating polymer. In another embodiment the fluoropolymer at least partially encapsulated by an encapsulating polymer comprises the fluoropolymer in a range of between about 40 weight percent to about 60 weight percent by weight of the fluoropolymer, and the encapsulating polymer in the range of between about 60 weight percent to about 40 weight percent by weight of the encapsulating polymer.

The fluoropolymer at least partially encapsulated by an encapsulating polymer is present in a range of between about 0.5 weight percent and about 60 weight percent based on the total weight percent of the resin composition. In one embodiment of the present invention the fluoroadditive is present in a range of between about 5 weight percent and about 40 weight percent being preferred, in a range of between about 5 weight percent and about 35 weight percent being more preferred and in a range of between about 10 weight percent and about 30 weight percent being even more preferred.

In one embodiment of the present invention the filler is present in a range of between about 0.5 weight percent to about 60 weight percent based on the total weight of the resin composition. In another embodiment the filler is present in a range of between about 5 weight percent to about 50 weight percent based on the total weight of the resin composition. In yet another embodiment the filler is present in a range of between about 10 weight percent to about 30 weight percent based on the total weight of the resin composition. The particle size of the filler may typically be in the range of between about 10 nanometers (nm) to about 100 micron.

In one embodiment the fillers could optionally be surface modified. The surface modification in context of the present invention would mean the durable attachment of a coupling agent to the surface of a mineral particle and to its surrounding organic matrix. The surface modification is a means by which the fillers and the polymer matrix are made compatible and are durably bonded, facilitating the uniform distribution of fillers into liquid or molten polymers. Typically coupling agents are employed for this purpose. The coupling agent cannot be removed from the filler surface by hydrolysis, solvolysis, extraction, or any other mechanism to which the filler-matrix composite may be exposed in use. Surface modifiers facilitate deagglomeration and uniform dispersion of the mineral particles and also serve to improve impact, tensile, flexural, and dielectric properties in plastics and elastomers; film integrity, substrate adhesion, weathering and service life in coatings; and application and tooling properties, substrate adhesion, cohesive strength, and service life in adhesives and sealants. In one embodiment of the present invention the coupling agents is at least one selected from the group consisting of silanes, titanates, zirconates, zircoaluminates, carboxylated polyolefines, chromates, chlorinated paraffins, organosilicon chemicals, and reactive cellulosics.

Optionally the resin composition of the present invention may further contain any conventional additive such as extenders, lubricants, flow modifiers, fire retardants, pigments, dyes, colorants, UV stabilizers, antioxidants, impact modifiers, plasticizers, optical brighteners, flame proofing agents; anti-static agents, blowing agents, etc. Some non-limiting examples of the foresaid additives are stated below. The antioxidants, such as, e.g., organophosphates , e.g., tries(only-phenyl)phosphite, (2,4,6-tri-tert-butylphenyl)(2-butyl-2-ethyl-1,3-propanediol)phosphite, bis(2,4-di-t-butylphenyl)pentaerythritol diphosphite or distearyl pentaerythritol diphosphite, as well as alkylated monophenols, polyphenols, alkylated reaction products of polyphenols with dienes, such as, e.g., butylated reaction products of para-cresol and dicyclopentadiene, alkylated hydroquinones, hydroxylated thiodiphenyl ethers, alkylidene-bisphenols, benzyl compounds, acylaminophenols, esters of beta-(3,5-di-tert-butyl-4-hydroxyphenol)-propionic acid with monohydric or polyhydric alcohols, esters of beta-(5-tert-butyl-4-hydroxy-3-methylphenyl)-propionic acid with monohydric or polyhydric alcohols, esters of beta-(5-tert-butyl-4-hydroxy-3-methylphenyl) propionic acid with mono- or polyhydric alcohols, esters of thioalkyl or thioaryl compounds, such as, e.g., distearylthiopropionate, dilaurylthiopropionate, ditridecylthiodipropionate, amides of beta-(3,5-di-tert-butyl-4-hydroxyphenol)-propionic acid may be used; Lubricants may be compounds of sodium, calcium or magnesium salts of lauric acid, palmitic acid, oleic acid or stearic acid; pentaerythritol tetrastearate, EBS wax, silicone fluids, fluoropolymers; flame retardant additives such as , e.g., halogen-containing organic flame retardant compounds, including fluoropolymers a described, organophosphate flame retardant compounds and borate flame retardant compounds. flame retardants there may be mentioned phosphoric acid ester compounds including trimethyl phosphate, triethyl phosphate, tributyl phosphate, trioctyl phosphate, tributoxyethyl phosphate, triphenyl phosphate, tricresyl phosphate, cresylphenyl phosphate, octyldiphenyl phosphate, diisopropylphenyl phosphate, tris(chloroethyl)phosphate, and polyphosphates, such as alkoxy-substituted bisphenol A bisphosphate, hydroquinone bisphosphate, resorcin bisphosphate, trioxybenzene triphosphate, halogen-containing compounds such as tetrabromobisphenol A, decabromodiphenyl oxide, hexabromocyclodecane, octabromodiphenyl ether, bistribromophenoxyethane, ethylene bistetrabromophthalimide, tribromophenol, halogenated epoxy oligomers obtained by reaction between halogenated bisphenol A and epichlorohydrin, carbonate oligomers with halogenated bisphenol A as a constituent, halogenated polystyrene, chlorinated polyolefins and polyvinyl chloride; and metal hydroxides, metal oxides, sulfamic acid compounds, etc; metal deactivators, such as, e.g., N,N′-diphenyloxalic acid diamide, 3-salicyloylamino-1,2,4-triazole, N-salicylal-N′-salicyloylhydrazine, N,N′bis-salicyloylhydrazine, N,N′-bis-(3,5-di-tert-butyl-4-hydrophenylpropionyl)-2-hydrazine, bis-benzyliden-oxalic acid dihydrazide, oxanilide, isophthalic acid dihydrazide, sebacic acid-bis-phenylhydrazide, bis-benzylidebeoxalic acid dihydrazide, N-salicylol-N′-salicylalhydrazine, 3-salicyloyl-amino-1,2,4-triazole or N,N-bis-salicyloyl-thiopropionic acid dihydrazide may also be used.

The neutralizers may be for example, melamine, polyvinylpyrrolidone, dicyandiamide, triallyl cyanurate, urea derivatives, hydrazine derivatives, amines, polyamides, and polyurethanes; alkali metal salts and alkaline earth metal salts of higher fatty acids, such as for example, calcium stearate, calcium stearoyl lactate, calcium lactate, zinc stearate, magnesium stearate, sodium ricinoleate, and potassium palmitate; antimony pyrocatecholate, zinc pyrocatecholate, and hydrotalcites and synthetic hydrotalcites may also be used. Lithium, sodium, magnesium, calcium, and aluminum. In other embodiments, hydroxy carbonates, magnesium zinc hydroxycarbonates, magnesium aluminium hydroxycarbonates, and aluminium zinc hydroxycarbonates; as well as metal oxides, such as zinc oxide, magnesium oxide and calcium oxide; peroxide scavengers, such as, e.g., (C₁₀-C₂₀) alkyl esters of beta.-thiodipropionic acid, such as for example the lauryl, stearyl, myristyl or tridecyl esters; mercapto benzimidazole or the zinc salt of 2-mercaptobenzimidazole, zinc-dibutyldithiocarbamate, dioctadecyldisulfide, and pentaerythritol tetrakis(.beta.-dodecylmercapto)propionate may also be used.

In yet another embodiment, the optional additive is a polyamide stabilizer, such as for example, copper salts in combination with iodides and/or phosphorus compounds and salts of divalent manganese. Examples of sterically hindered amines include but are not restricted to triisopropanol amine or the reaction product of 2,4-dichloro-6-(4-morpholinyl)-1,3,5-triazine with a polymer of 1,6-diamine, N,N′Bis(-2,2,4,6-tetramethyl-4-piperidenyl) hexane. In one embodiment, the optional additives and stabilizers described herein are present in an amount effective to further improve the composition stability and properties.

The thermoplastic resin composition of the present invention is prepared by mixing the matrix polymer, fluoropolymer at least partially encapsulated by an encapsulating polymer and the filler to form a first mixture. The mixing could be typically carried out in any conventional mixer like drum mixers, ribbon mixers, vertical spiral mixers, Muller, mixers, sigma mixers, chaotic mixers, static mixers and the like. In one embodiment of the present invention the mixing is typically carried out at a temperature at least below the degradation temperature of the matrix polymer, fluoropolymer or the encapsulating polymer which ever is lower. The first mixture is then melt mixed in any conventional method, such as extrusion kneading or roll kneading, a two-roll mill, in a Banbury mixer or in a single screw or twin-screw extruder, or in any high shear device, mixing of the components leads to preparing a molten mixture of a substantially homogenous composition. The melt mixing could be a continuous or a batch process. In addition to the above methods the melt mixing could be carried out by any one of the following means these include but are not restricted to double blade batch mixer, vertical shaft mixer, planetary mixer, Becken blade mixer, dispersion blade mixer, sigma mixer, continuous batch mixers of the type hydrofoil, turbine blade, CF impeller blade, static mixers and the like. In one embodiment the extruder may be a single screw or a twin screw extruder. The twin screw extruder could be co-rotating, counter rotating, intermeshing, non-intermeshing etc, planetary gear extruder readco continuous mixer are some non limiting examples. Those of ordinary skill in the art will be able to adjust blending times and temperatures, as well as component addition location and sequence, without undue additional experimentation. Also optionally, a portion of the thermoplastic resin may be mixed with the polytetrafluoroethylene-containing powder mixture to prepare a master batch, and then the remaining thermoplastic resin may be added and mixed therewith later for multistage mixture.

Processing temperatures in embodiments of the invention are most often in the range of at least above the glass transition temperature of the matrix polymer and at least below the degradation temperature of the matrix polymer. In a temperature range of between about 20° C. and about 350° C. in some embodiments, and in the range of between about 50° C. and about 350° C. in other embodiments. In an alternate embodiment the processing temperature is most often in the range of between about 100° C. and about 300° C.

The molten mixture is subjected to shear in a high shear device and the composition so formed to particulate form, example by pelletizing or grinding the composition. The molten mixture also called the extrudate from the extruder may be fed into a die. Some non-limiting examples of die used could be annular die, coat hanger die, spiral mandrel die, crosshead die, T-die, fishtail die, spider die, single or double roller die, profile extrusion die. The composition of the present invention can be molded into useful articles by a variety of means by many different processes to provide useful molded products such as injection, extrusion, rotation, foam molding, calender molding and blow molding and thermoforming, compaction, melt spinning form articles.

The articles of this invention are characterized by the usual beneficial properties of high modulus, good ductility and impact in addition to weatherability as evidenced by improved resistance to ultraviolet radiation and maintenance of gloss, solvent resistance and recycling capability by regrind and the like. The properties of high modulus, good ductility and impact, employ the composition as a substrate for further production of articles of the invention.

Articles of the invention particularly include but are not limited to articles, which will be exposed to UV-light, whether natural or artificial, during their lifetimes, and most particularly outdoor and indoor articles. Suitable articles are exemplified by but are not limited to aircraft, automotive, truck, military vehicle (including automotive, aircraft, and water-borne vehicles), scooter, and motorcycle exterior and interior components, including panels, quarter panels, rocker panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); computer; desk-top computer; portable computer; lap-top computer; palm-held computer housings; monitor; printer; keyboards; FAX machine; copier; telephone; phone bezels; mobile phone; radio sender; radio receiver; enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated painted articles; coated dyed articles; coated fluorescent articles; coated foam articles; and like applications. The invention further contemplates additional fabrication operations on said articles, such as, but not limited to, molding, in-mold decoration, baking in a paint oven, lamination, and/or thermoforming. The articles made from the composition of the present invention may be used widely in automotive industry, home appliances, electrical components, telecommunications.

### EXAMPLES

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. While only certain features of the invention have been illustrated and described herein, many modifications and changes will occur to those skilled in the art. Accordingly, these examples are not intended to limit the invention, as defined in the appended claims, in any manner.

The fluoropolymer additive composition (PTFE/SAN) has been synthesized by the method of aqueous emulsion polymerization as disclosed in U.S. Pat. No. 5,804,654.

### Examples

Polycarbonate available from General Electric Company as Lexan® polycarbonate resin 105 was employed as the matrix polymer in the examples mentioned. The relative amounts of the components (expressed in percent weight, based on the total weight of the respective thermoplastic resin composition) mentioned in Table 1 and 2 were subjected to dry blending and then fed into the extruder. The resin was then melt mixed at a barrel temperature of around 275° C. on a ZSK 25 co-rotating twin-screw extruder from WERNER and PFLEIDERER Co. The torque was maintained at 80 percent at a screw rotation rate of 300 rotations per minute and then fed into a high-speed pellatizer yielding a pelletized composition.

The resulting pellets were dried for at least 4 hours at 80° C. before injection molding into ASTM/ISO test specimens on an L&T Demag De-Tech 60T LNC4-E injection molding machine operated at a temperature of about 280° C.

TABLE 1

| | | | | | | | | Unnotch | |
|---|---|---|---|---|---|---|---|---|---|
| | | | | | Tensile | Yield | | Impact | |
| | | | Filler | Fluroadditive | Modulus | Stress | Break | Strength | |
| | Resin | Filler Type | (%) | (%) | (Gpa) | (Mpa) | Strain (%) | (KJ/m²) | CTE × 10⁻⁵ m/m/° C. |
| Ex1 | Polycarbonate | Silicon Carbide 8 Micron | 10 | 15 | 4.07 | 72.98 | 9.28 | NB | — |
| Ex2 | Polycarbonate | Mica (55 Micron) | 10 | 10 | 4.57 | 70.84 | 17.15 | NB | — |
| Ex3 | Polycarbonate | Silicon Carbide 0.4 Micron | 10 | 10 | 3.62 | 69.77 | 74.68 | NB | — |
| Ex4 | Polycarbonate | NYCO1 | 10 | 10 | 4.10 | 69.32 | 42.40 | NB | — |
| Ex5 | Polycarbonate | NYCO 2 | 10 | 10 | 4.03 | 68.87 | 41.04 | NB | — |
| Ex6 | Polycarbonate | Epoxy Coated Mica (55 | 10 | 10 | 4.36 | 74.49 | 16.64 | NB | — |
| | | Micron) | | | | | | | |
| Ex7 | Polycarbonate | Hydrous Aluminosilicate | 10 | 10 | 4.00 | 72.83 | 42.98 | NB | — |
| | | (Engelhard-ASP NC) | | | | | | | |
| Ex8 | Polycarbonate | Wollastonite 10 Micron | 10 | 10 | 4.00 | 73.88 | 11.80 | NB | — |
| | | (Wolkem 1008) | | | | | | | |
| Ex9 | Polycarbonate | Epoxy coated Talc | 10 | 10 | 4.68 | 76.56 | 17.36 | NB | — |
| Ex10 | Polycarbonate | Mica + Pigment (9 + 1) | 10 | 10 | 4.61 | 71.96 | 18.36 | NB | — |
| Ex11 | Polycarbonate | Mica (High Mol Wt TSAN) | 10 | 10 | 4.58 | 74.30 | 17.46 | NB | — |
| Ex12 | Polycarbonate | Carbon fiber (Fortafil 202) | 10 | 0 | 3.53 | 68.04 | 12.37 | 150.98 | — |
| Ex13 | Polycarbonate | Carbon fiber (Fortafil 202) | 10 | 10 | 5.74 | 76.74 | 6.72 | 154.25 | — |
| Ex14 | Polycarbonate | Carbon Fiber (Fortafil 202) + Mica | 10 | 10 | 4.94 | 73.47 | 5.61 | 194.78 | — |
| | | (55 Micron) (1:1) | | | | | | | |
| Ex15 | Polycarbonate | Mica (6Micron + 55 Micron) | 10 | 10 | 5.20 | 75.88 | 32.56 | NB | — |
| Ex16 | Polycarbonate | Mica (6Micron + 10 Micron) | 10 | 10 | 4.80 | 73.55 | 43.17 | NB | — |
| Ex17 | Polycarbonate | Mica (10 Micron) | 10 | 10 | 5.17 | 76.94 | 20.73 | NB | — |
| Ex18 | Polycarbonate | Mica (CF + Mic) | 10 | 10 | 5.83 | 64.05 | 6.16 | — | — |
| Ex19 | Polycarbonate | Mica (6 Micron) | 10 | 10 | 5.15 | 76.80 | 64.20 | NB | 4.05 |
| Ex20 | Polycarbonate | Silicon Carbide 8 Micron | 10 | 15 | 4.07 | 72.98 | 9.28 | NB | — |

NB = no break (high impact)

TABLE 2

| | | | | | | | | Unnotch | |
|---|---|---|---|---|---|---|---|---|---|
| | | | | | Tensile | Yield | | Impact | |
| | | | Filler | Fluroadditive | Modulus | Stress | Break | Strength | |
| | Resin | Filler Type | (%) | (%) | (GPa) | (MPa) | Strain (%) | (KJ/m²) | CTE × 10⁻⁵ m/m/° C. |
| Ex21 | Polycarbonate | Mica (55 Micron) | 5 | 5 | 3.39 | 66.68 | 76.17 | NB | — |
| Ex22 | Polycarbonate | Mica (55 Micron) | 7.5 | 7.5 | 4.04 | 69.02 | 61.39 | NB | — |
| Ex23 | Polycarbonate | Mica (6 Micron) | 12.5 | 12.5 | 6.37 | 81.92 | 19.88 | NB | — |
| Ex24 | Polycarbonate | Mica (6 Micron) | 15 | 15 | 7.19 | 84.44 | 11.48 | 233.23 | 3.60 |
| Ex25 | Polycarbonate | Mica (6 Micron) | 15 | 12.5 | 6.87 | 83.88 | 15.18 | NB | — |
| Ex26 | Polycarbonate | Silicon Carbide 0.4 | 10 | 15 | 4.14 | 73.13 | 34.85 | NB | — |
| | | Micron | | | | | | | |
| Ex27 | Polycarbonate | Nanoclay (Closite | 2.5 | 10 | 3.72 | 70.10 | 4.11 | 196.05 | — |
| | | 20A) | | | | | | | |

NB = no break (high impact)

TABLE 3

| | | | | | | | | Unnotch | |
|---|---|---|---|---|---|---|---|---|---|
| | | | | | | Yield | Break | Impact | |
| | | | Filler | Fluro- | Tensile | Stress | Strain | Strength | |
| | Resin | Filler Type | (%) | additive (%) | Modulus (GPa) | (MPa) | (%) | (KJ/m²) | CTE × 10⁻⁵ m/m/° C. |
| Ex28 | Polycarbonate/ | Mica (6 Micron) | 10 | 10 | 4.66 | 68.19 | 27.25 | NB | 4.64 |
| | ABS(28%) | | | | | | | | |
| Ex29 | Polycarbonate | Talc | 10 | 5 | 4.25 | 69.21 | 41.34 | NB | — |
| Ex30 | Polycarbonate/ | Mica (6 Micron) | 10 | 10 | 5.68 | 84.63 | 23.29 | NB | — |
| | Epoxy(5%) | | | | | | | | |
| Ex31 | Polycarbonate/ | Mica (6 Micron) | 10 | 10 | 5.79 | 83.40 | 17.57 | 224.44 | — |
| | BPADP(5%) | | | | | | | | |
| Ex32 | Polycarbonate/ | Talc | 10 | 5 | 3.92 | 60.24 | 60.94 | NB | — |
| | ABS(18%) | | | | | | | | |
| Ex33 | Polycarbonate | Mica (6 Micron) | 10 | 5 | 4.94 | 71.79 | 22.92 | NB | — |
| Ex34 | PC/PBT (60/40) | Mica (6 Micron) | 10 | 10 | 5.5 | 80.5 | 16.23 | NB | 6.12 |
| Ex35 | PC/PBT/MBS | Mica (6 Micron) | 7.5 | 7.5 | 3.94 | 64.01 | 43.11 | NB | — |
| | (40/35/10) | | | | | | | | |
| Ex36 | PC/PBT/MBS | Mica (6 Micron) | 10 | 10 | 4.63 | 66.91 | 18.76 | NB | — |
| | (37/33.5/9.5) | | | | | | | | |
| Ex37 | ABS | Mica (6 Micron) | 10 | 15 | 4.32 | 57.84 | 11.26 | — | — |

NB = no break (high impact);
ABS = acrylonitrile butadiene styrene copolymer;
BPADP = bisphenol A diphenylphosphate;
PBT = polybutyleneterephthalate;
MBS = methylmethacrylate butadiene styrene copolymer.

TABLE 4

| | | | | | | | Unnotch |
|---|---|---|---|---|---|---|---|
| | | | | | Tensile | Yield | Impact |
| | | Filler | Filler | | Modulus | Stress | Strength |
| | Resin | Type | (%) | PTFE (%) | (GPa) | (Mpa) | (KJ/m²) |
| Ex38 | ABS | — | — | — | 2.396 | 48.784 | 93.15 |
| Ex39 | ABS | — | — | 5% | 2.734 | 51.412 | 89.22 |
| Ex40 | ABS | — | — | 10 | 2.78 | 51.23 | 64.7 |
| Ex41 | ABS | Mica | 10 | 10 | 3.92 | — | — |

ABS = acrylonitrile butadiene styrene copolymer

TABLE 5

| | | | | | Flame | Flame | |
|---|---|---|---|---|---|---|---|
| | | | | Fluro- | Retardancy | Retardancy | |
| | | | Filler | additive | (UL Rating @ | (UL Rating @ | Gloss @ |
| | Resin | Filler Type | (%) | (%) | 1.5 mm) | 1.2 mm) | 60° C. |
| Ex13 | Polycarbonate | Carbon fiber (Fortafil 202) | 10 | 10 | V1 | V1 | 55 |
| Ex14 | Polycarbonate | Carbon Fiber (Fortafil 202) + | 10 | 10 | V0 | V0 | 40 |
| | | Mica (55 Micron) (1:1) | | | | | |
| Ex19 | Polycarbonate | Mica (6 Micron) | 10 | 10 | — | — | 51 |
| Ex28 | Polycarbonate/ABS | Mica (6 Micron) | 10 | 10 | — | — | 55 |
| | (28%) | | | | | | |
| Ex31 | Polycarbonate/BPADP | Mica (6 Micron) | 10 | 10 | — | — | 53 |
| | (5%) | | | | | | |
| Ex35 | Polycarbonate/ | Mica (6 Micron) | 10 | 10 | — | — | 44 |
| | PBT (60/40) | | | | | | |

ABS = acrylonitrile butadiene styrene copolymer;
BPADP = bisphenol A diphenylphosphate;
PBT = polybutyleneterephthalate;

### Comparative Examples (C Ex1-C Ex16)

In Table 6 the abbreviations are defined as follows: CEx.=Comparative Example, which provide a comparison with this invention and/or its preferred embodiments. Comparative Example 1 was the polycarbonate without the addition of either filler or the fluoro additive. Comparative examples CEx2-CEx11 are the composition prepared under the same conditions as mentioned above without the addition of the fluoroadditive. The comparative examples CEx12-CEx16 are the composition prepared under the same conditions as mentioned above without the addition of the filler.

TABLE 6

| | | | | | | | | Unnotch | |
|---|---|---|---|---|---|---|---|---|---|
| | | | | | Tensile | Yield | Break | Impact | |
| | | | | | Modulus | Stress | Strain | Strength | |
| | Resin | Filler Type | Filler | Fluroadditive | (GPa) | (MPa) | (%) | (KJ/m²) | CTE × 10⁻⁵ m/m/° C. |
| C Ex1 | Polycarbonate | — | 0 | 0 | 2.31 | 62.65 | 84.40 | NB | 8.04 |
| C Ex2 | Polycarbonate | Mica (55 Micron) | 10 | 0 | 3.39 | 68.79 | 7.89 | 82.8 | — |
| C Ex3 | Polycarbonate | Talc | 10 | 0 | 3.49 | — | 6.88 | 11.3 | — |
| C Ex4 | Polycarbonate | Epoxy Silane coated | 10 | 0 | 2.75 | 65.64 | 12.51 | 116.7 | — |
| | | Talc | | | | | | | |
| C Ex5 | Polycarbonate | Wollastonite (NYCO 1) | 10 | 0 | 3.41 | | 0.38 | 12.5 | — |
| C Ex6 | Polycarbonate | Wollastonite (NYCO 2) | 10 | 0 | 3.23 | 42.42 | 1.63 | 11.8 | — |
| C Ex7 | Polycarbonate | Silicon Carbide (0.4 | 10 | 0 | 2.95 | 66.18 | 17.73 | NB | — |
| | | Micron) | | | | | | | |
| C Ex8 | Polycarbonate | Silicon Carbide (8 | 10 | 0 | 2.96 | 67.08 | 28.97 | NB | — |
| | | Micron) | | | | | | | |
| C Ex9 | Polycarbonate | Silicon Carbide (8 | 15 | 0 | 3.14 | 68.71 | 14.35 | NB | — |
| | | Micron) | | | | | | | |
| C Ex10 | Polycarbonate | Mica (6 Micron) | 10 | 0 | 3.88 | 69.48 | 31.57 | 178.1 | 5.46 |
| C Ex11 | Polycarbonate | Epoxy Coated Mica (55 | 10 | 0 | 3.36 | 66.39 | 15.28 | 194.51 | — |
| | | Micron) | | | | | | | |
| C Ex11 | Polycarbonate | Hydrous | 10 | 0 | 3.41 | 71.91 | 10.01 | 202.31 | — |
| | | Aluminosilicate | | | | | | | |
| | | (Engelhard-ASP NC) | | | | | | | |
| C Ex12 | Polycarbonate | — | 0 | 5 | 2.74 | 64.13 | 77.52 | NB | — |
| C Ex13 | Polycarbonate | — | 0 | 10 | 3.12 | 31.91 | 61.16 | NB | 6.64 |
| C Ex14 | Polycarbonate | — | 0 | 15 | 3.56 | 33.84 | 49.78 | NB | — |
| C Ex15 | Polycarbonate | — | 0 | 20 | 4.83 | 73.85 | 10.79 | 211.61 | — |
| CEx16 | ABS | — | 0 | 15 | 3.12 | 51.39 | 18.63 | 240.7 | — |

NB = no break

The tensile properties were determined using ISO 527 and the Izod Impact were measured using the standard ISO 180/U method. The gloss for the samples were measured using the ASTM D 523. The flame retardancy for the resins was measured by the standard Underwriter Laboratory 94 method and rated according to the same method. The coefficient of thermal expansion (CTE) measurements were done using ASTM E 831. The data in Tables 1-5 show that the article with the composition of the invention possess surprisingly (descriptive higher and numbers) properties of modulus and break strain by the combination of the matrix polymer, filler and encapsulated fluoropolymer. The formulations inherently possesses flame retardant characteristics and have low gloss and low CTE when compared to matrix polymer.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All patents and published articles cited herein are incorporated herein by reference.

1. A resin composition comprising:
a matrix polymer; and
a combination of:
a fluoropolymer at least partially encapsulated by an encapsulating polymer; and
a filler.

2. The composition of claim 1 wherein said composition has an improved tensile modulus and/or elongation at break relative to a composition comprising matrix polymer and only component (1) or (2) of the combination.

3. The composition according to claim 1, wherein said matrix polymer is at least one selected from the group consisting of polyvinyl chloride, polyolefins, polyesters, polyamides, polysulfones, polyimides, polyetherimides, polyether sulfones, polyphenylene sulfides, polyether ketones, polyether ether ketones, ABS resins, polystyrenes, polybutadiene, polyacrylates, polyalkylacrylates, polyacrylonitrile, polyacetals, polycarbonates, polyphenylene ethers, ethylene-vinyl acetate copolymers, polyvinyl acetate, liquid crystal polymers, ethylene-tetrafluoroethylene copolymers, aromatic polyesters, polyvinyl fluoride, polyvinylidene fluoride, polyvinylidene chloride, tetrafluoroethylene, and mixtures, copolymers, reaction products, blends and composites comprising at least one of the foregoing polymers.

4. The composition according to claim 3, wherein said matrix polymer comprises polycarbonate and mixtures, copolymers, reaction products, blends and composites comprising polycarbonate.

5. The composition according to claim 1, wherein said fluoropolymer is selected from the group consisting of structural units derived from one or more fluorinated alpha.-olefin monomers homopolymers, copolymers comprising structural units derived from two or more fluorinated alpha.-olefin copolymers, copolymers comprising structural units derived from one or more fluorinated monomers and one or more non-fluorinated monoethylenically unsaturated monomers and combinations thereof.

6. The composition according to claim 5, wherein said fluoropolymer is at least one selected from the group consisting of polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, ethylene chlorotrifluoroethylene and combinations thereof.

7. The composition according to claim 1, wherein said encapsulating polymer is at least one selected from the group consisting of vinyl polymers, acrylic polymers, polyacrylonitrile, polystyrenes, polyolefins, polyesters, polyurethanes, polyamides, polysulfones, polyimides, polyetherimides, polyphenylene ethers, polyphenylene sulfides, polyether ketones, polyether ether ketones, ABS resins, polyethersulfones, poly(alkenylaromatic) polymers, polybutadiene, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, tetrafluoroethylene, mixtures, copolymers, reaction products, and composites comprising at least one of the foregoing polymers.

8. The composition according to claim 7, wherein said encapsulating polymer is at least one selected from the group comprising styrene-acrylonitrile and acrylonitrile-butadiene-styrene copolymers, alpha.-alkyl-styrene-acrylonitrile copolymers, .alpha.-methylstyrene-acrylonitrile copolymers, styrene-butadiene rubbers , and combinations thereof.

9. The composition according to claim 1, wherein said fluoropolymer at least partially encapsulated by an encapsulating polymer is present in a range of between about 0.5 weight percent and about 60 weight percent based on the total weight percent of the resin composition.

10. The composition according to claim 1, wherein said fluoropolymer and the encapsulating polymer are present in a range between about 80 percent to about 20 percent by weight of fluoropolymer and about 20 percent to about 80 percent by weight of the encapsulating polymer.

11. The composition according to claim 1, wherein said fluoropolymer and the encapsulating polymer are present in a range between about 60 percent to about 40 percent by weight of fluoropolymer and about 40 percent to about 60 percent by weight of the encapsulating polymer.

12. The composition according to claim 1, wherein said filler is at least one selected from the group consisting of calcium carbonate, mica, kaolin, talc, glass fibers, carbon fibers, carbon nanotubes, magnesium carbonate, sulfates of barium, calcium sulfate, titanium, nano clay, carbon black, silica, hydroxides of aluminium or ammonium or magnesium, zirconia, nanoscale titania, and combinations thereof.

13. The composition according to claim 12, wherein said filler is at least one selected from the group consisting of mica, talc, silicon carbide and combinations thereof.

14. The composition according to claim 12, wherein said filler is present in a range of between about 0.5 weight percent and about 60 weight percent based on the total weight percent of the resin composition.

15. An article comprising the composition of claim 1.

16. A method of preparing a resin composition comprising
mixing a matrix polymer, a fluoropolymer at least partially encapsulated by a encapsulating polymer, and a filler to form a first mixture;

17. The method according to claim 16, including the steps of
melting said first mixture to form a molten mixture;
extruding said molten mixture in an extruder to form an extrudate; and
molding said extrudate.

18. The method according to claim 16, wherein said composition is processed to an improved tensile modulus and/or elongation at break relative to a composition comprising the matrix polymer with only said fluoropolymer at least partially encapsulated by an encapsulating polymer or filler.

19. The method according to claim 17, wherein said melting is carried out at a temperature of at least above the glass transition temperature of the matrix polymer.

20. The method according to claim 17, further comprising the step of stretching the molten mixture under shear.

21. An article made according to the method of claim 16, said method comprising the steps of:
mixing a matrix polymer, a fluoropolymer at least partially encapsulated by a encapsulating polymer, and a filler to form a first mixture;
melting said first mixture to form a molten mixture;
extruding said molten mixture in an extruder to form an extrudate; and
molding said extrudate to said articles.

22. An article comprising:
a matrix polymer consisting essentially of polycarbonate or polycarbonate blends;
a fluoropolymer at least partially encapsulated by a encapsulating polymer;
and a filler consisting essentially of mica or talc or silicon carbide.

23. The article according to claim 22, wherein said article has an improved tensile modulus and/or elongation at break relative to a composition comprising the matrix polymer with only said fluoropolymer at least partially encapsulated by an encapsulating polymer or filler.
